(19) United States
(12) Patent Application Publication
(10) Pub. No.: US 2015/0039761 A1
(43) Pub. Date: Feb. 5, 2015

(54) CONTENT SHARING WITHIN A PRIVATE SUER GROUP

(71) Applicant: Nokia Corporation, Espoo (FI)

(72) Inventors: Basavaraj Patil, Coppell, TX (US); Teemu Savolainen, Espoo (FI)

(73) Assignee: Nokia Corporation, Espoo (FI)

(21) Appl. No.: 14/117,982

(22) PCT Filed: May 20, 2011
(86) PCT No.: PCT/US11/37461

§ 371 Date: Feb. 1, 2014

(51) Int. Cl. H04L 12/927; H04L 29/08

(52) U.S. Cl. CPC H04L 47/80; H04L 67/10
USPC 709/225

(57) ABSTRACT

Methods and apparatus, including computer program products, are provided for sharing content. In some embodiments, there is provided a method. The method may include storing, in the first user equipment, content in a location represented by an identifier reachable by a group comprising at least one of a plurality of entities, wherein the location is under the control of the first user equipment; and sharing with the group the stored content by enabling access to the stored content in the location represented by the identifier and located in the first user equipment. Related systems, methods, and articles of manufacture are also disclosed.

### FIELD

The subject matter disclosed herein relates to content sharing.

### BACKGROUND

Content is typically shared by users via web sites including Facebook, vimeo, Flickr, YouTube, and so forth. These web sites allow a user to post content, such as music, video, pictures, and the like, to a server at the web site. Once the content is posted, other users may access the content. For example, a user may post a picture to Flickr or Facebook, such that the picture can be seen by virtually any user accessing the Internet. Thus, these content sharing web sites have made it easier to share content on the Internet.

### SUMMARY

Methods and apparatus, including computer program products, are provided for sharing content. In some embodiments, there is provided a method. The method may include storing, in the first user equipment, content in a location represented by an identifier reachable by a group comprising at least one of a plurality of entities, wherein the location is under the control of the first user equipment; and sharing with the group the stored content by enabling access to the stored content in the location represented by the identifier and located in the first user equipment.

In some variations of some of the embodiments disclosed herein, one or more of the following may be included. The identifier may further comprises at least one of a uniform resource locator resolving to the location and a mobile internet protocol home address comprising a public internet protocol address reachable by the at least one of the plurality of entities. The access to the content stored in the location may be controlled by enabling access to the content based on a designation, by the first user equipment, of the group comprising the at least one of the plurality of entities. The first user equipment may designate the group by receiving a selection of the at least one of the plurality of entities. The first user equipment may designate the content for sharing among the group, wherein the designated content is stored in the location under the control of the first user equipment. A notification message including the identifier may be sent to the group to notify the at least one of the plurality of entities of the stored content available in the location under the control of the first user equipment. The group comprising the at least one of a plurality of entities may access the stored content in the location comprising a directory. The first user equipment may comprise a memory, and wherein the location under the control of the first user equipment comprises the memory. The location under the control of the first user equipment may further comprise a cache including the content, wherein the cache is coupled to the first user equipment and the home agent. The group may comprise a closed group.

The above-noted aspects and features may be implemented in systems, apparatus, methods, and/or articles of manufacture, such as for example a computer program product, depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a simplified block diagram of a system for sharing content in accordance with some exemplary embodiments;

FIG. 2 depicts a simplified block diagram of another system for sharing content in accordance with some exemplary embodiments;

FIG. 3 depicts an example of a process for sharing content stored on the user equipment in accordance with some exemplary embodiments;

FIG. 4 depicts a page presented at a user interface with an icon to enable content sharing;

FIG. 5 depicts a page presented at a user interface with an icon for selecting a closed group and another icon for sending a notification to the closed group in accordance with some exemplary embodiments;

FIG. 6 depicts a page including contact information for a user and contact information for the user's shared content in accordance with some exemplary embodiments;

FIG. 7 depicts an example of a user equipment in which content is stored for sharing with the closed group in accordance with some exemplary embodiments;

FIG. 8 depicts a home agent which provides a mobile internet protocol (IP) home address, so that other devices can locate the shared content at the user equipment in accordance with some exemplary embodiments; and

FIG. 9 depicts a sequence diagram for sharing content stored on the user equipment.

Like labels are used to refer to same or similar items in the drawings.

### DETAILED DESCRIPTION

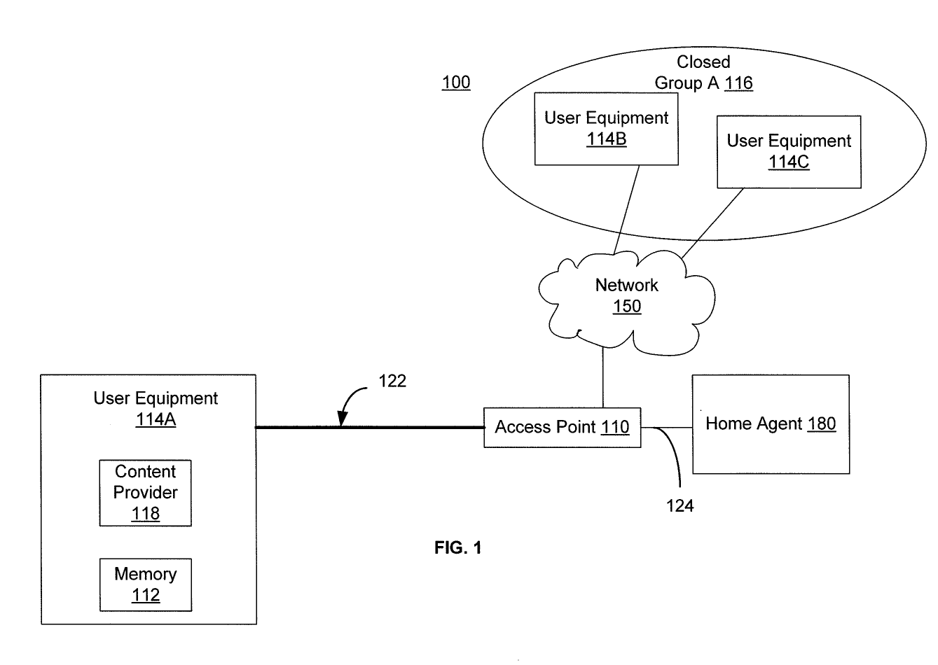

FIG. 1 depicts a simplified functional block diagram of a system 100 consistent with some exemplary embodiments. The system 100 may, in some exemplary embodiments, include one or more devices, such as user equipment 114A-C, one or more network nodes, such as an access point 110 and a home agent 180, which are coupled by a network, such as network 150. The user equipment 114A may further include a content provider 118 and memory 112. The user equipment 114A may share content, such as photos, video, music, and the like, stored in memory 112 with one or more devices in one or more groups, but the shared content is under the control of user equipment 114A. The group(s) may comprise one or more devices, such as closed group 116. For example, a group may comprise one or more devices designated by the user equipment 114A to access the shared content under the control of user equipment 114A. The group may also comprise one or more devices corresponding to so-called “friends” on a social networking web site, device(s) having access to Internet, and/or any other devices having access to the shared content under the control of user equipment 114A.

In some exemplary embodiments, content provider 118 may have an internet protocol (IP) address, such as a mobile IP version 6 home address provided by home agent 180, which makes content provider 118 and the content stored in memory 112 accessible to other devices. In this example, user equipment 114A may select content to share with a group, such as closed group 116. Although the shared content may be shared with a closed group, the user equipment 114A may also indicate via a selection that the shared content is to be shared generally, such as with any device having Internet access. In any case, the user equipment 114A may store that content in memory 112, and send a notification message including a locator, such as a uniform resource locator, to the stored content to enable the devices, such as user equipment 114B-C, to use the locator to access the shared content. The closed group 116 refers to a group of one or more devices (and/or corresponding users) defined by the user equipment 114A (e.g., membership is open only to devices defined by user equipment 114A). The closed group 116 may also be considered private in the sense that only the devices in the closed group can access content served by content provider 118 and stored in memory 112. By storing content in the user equipment 114A and designating a group which can access the content, the user equipment 114A controls access to the content, providing greater privacy and control over a user's content.

In some exemplary embodiments, the user equipment 114A-C may each comprise one or more of the following: at least one processor, at least one non-transitory computer-readable storage medium (e.g., memory, storage, and the like), a radio interface, a user interface, and the like. The user equipment 114A-C may each be implemented as, for example, a mobile device, a stationary device, a mobile station, a mobile unit, a subscriber station, a wireless terminal, a tablet, a wireless gaming device, a smart phone, a cellular phone, and the like. In some exemplary embodiments, user equipment 114A is a mobile device which roams in one or more public land mobile networks (e.g., cellular networks) as well as other wireless networks, such as 802.11 WiFi networks, and the like. Moreover, user equipment 114A may include content, such as photos, videos, music, and the like, stored in memory 112 and served by content provider 118, which is assigned a mobile IP home address by home agent 180. In this example, the user equipment 114A may also define one or more closed groups. In the example of FIG. 1, the user equipment 114A defines closed group 116 to include devices, such as user equipment 114B-C, for sharing content—making accessible content stored in memory 112 to the defined closed group 116 comprising user equipment 114B-C.

In some exemplary embodiments, the user equipment 114A may communicate with access point 110 via wireless link 122. For example, access point 110 may be implemented as a base station, such as a an Node B base station, an evolved Node B base station, a femtocell base station, and/or any other type of base station, although access point 110 may also be implemented as any other type of access point, such as a 802.11 WiFi access point and the like. When implemented as a base station of a public land mobile network, the access point 110 may comply with standards, such as one or more of the following: the IEEE 802.16 series of standards (commercially known as WiMAX); GERAN (GSM/EDGE Radio Access Network); UTRAN (UMTS Terrestrial Radio Access Network); E-UTRAN (Evolved-UTRAN, which is also referred to as Long Term Evolution (LTE) and/or Long Term Evolution-Advanced (LTE-A)); and any other wireless technology/standard as well as any subsequent additions or revisions to those standards.

The access point 110 may couple via link 124 to home agent 180, which may be located in a home network of user equipment 114A, and the access point 110 may couple to user equipment 114B-C via network 150, such as the Internet and/or any other network or communication mechanism. The home agent 180 may be implemented on a server (e.g., at least one processor and at least one memory). In some exemplary embodiments, the home agent 180 may be implemented as a mobile internet protocol (IP) home agent, which assigns mobile IP home addresses to user equipment 114A. For example, the home agent 180 may assign a mobile IP home address to the user equipment and track the care-of address of the user equipment when roaming.

In some exemplary embodiments, the home agent 180 may assign an internet protocol (IP) address, such as a mobile IP version 6 home address. For example, the home agent 180 may be configured to assign a mobile IP home address to user equipment 114A including content provider 118 in accordance with a dual-stack mobile IP version 6 (v6) protocol, such as for example the dual-stack protocol define by RFC-5555, Mobile IPv6 Support for Dual Stack Hosts and Routers, June 2009. The home agent 180 may also be configured in accordance with transport layer security (TLS), such as for example draft-ietf-mext-mip6-tls (http://www.ietf.org/id/draft-ietf-mext-mip6-tls-00.txt) including the security bootstrapping mechanisms therein. In some exemplary embodiments, Mobile IPv6/Dual-stack Mobile IPv6 may be used to enable a mobile node, such as user equipment 114A, to be assigned a persistent internet protocol address, such as a mobile internet protocol home address, at which the mobile node can be reached irrespective of the access network to which the mobile node is connected. Moreover, this persistent internet protocol address, such as a mobile internet protocol home address, may enable traversal of network address translators present in many networks.

In the above-noted example, the user equipment 114A is publicly reachable by other devices, such as user equipment 114B-C, on the Internet via the mobile IPv6 home address assigned by the home agent 180. Even when the user equipment 114A is coupled to access point 110 via a cellular connection to a base station and/or a wireless link to a WiFi access point, the user equipment 114A (which may also include a dual-stack mobile IPv6 client) may obtain a mobile IPv6 home address from the home agent 180, making user equipment 114A reachable regardless of whether the user equipment 114A is stationary or roams to other networks including public land mobile networks.

Once the user equipment 114A is assigned an address, such as a mobile IPv6 home address, by the home agent 180, content provider 118 may make its content accessible to other devices, such as the user equipment 114B-C of closed group 116. In some exemplary embodiments, the content provider 118 may be configured as a server to make content, such as photos, music, video, documents, and the like, available to a closed and/or private group defined by user equipment 114A. For example, user equipment 114A may define closed group 116 comprising friends, family, and the like, and the closed group 116 may be granted access to content served by content provider 118 and stored at memory 112, although the content may be shared with any other devices coupled to the Internet (e.g., the group including the “Internet at large”).

The user equipment 114A may define (e.g., selects, configures, designates, etc.) closed group 116 as a private group, such as a group of friends or family members whose identifiers (e.g., addresses, phone numbers, email addresses, account numbers, International Mobile Subscriber Identity, or any other identifying information) are made part of a so-called “phonebook” or share group with which user equipment 114 may share content. Moreover, user equipment 114A may define a plurality of closed groups 116.

In some exemplary embodiments, content to be accessed, and thus shared, via content provider 118 may be stored in memory 112. Specifically, the content to be shared may be stored in, for example, a specific directory for sharing with a group, such as closed group 116. To illustrate with an example, when a photo is taken at user equipment 114A, the user equipment 114A may designate the photo for accessing and sharing with closed group 116 defined by user equipment 114A. When the photo is designated for sharing, the photo may be flagged, moved to, and/or associated with, a specific directory in memory 112. This specific directory located in memory 112 may be restricted, so that the contents of the specific directory are only accessible to the members of closed group 116, which in this example includes user equipment 114B-C. Once the content is designated for sharing and stored in the specific directory in memory 112, user equipment 114B-C of group 116 may access the content in the specific directory of memory 112 by accessing a locator, such as a uniform resource identifier or uniform resource locator, linking to content provider 118 and the corresponding shared content in the specific directory of memory 112. For example, selecting a uniform resource locator at user equipment 114B may direct (e.g., resolve to the assigned mobile IP home address and then corresponding care-of address) user equipment 114B to the content designated for sharing in the specific directory of memory 112.

In some exemplary embodiments, user equipment 114A may send a notification, such as an email, short message service message, and the like, to each of the devices of closed group 116 designated to receive the shared content. For example, when a new photo is taken and the user equipment 114A designates the new photo for sharing with one or more closed groups, such as closed group 116, a message including a uniform resource locator to the new photo may be sent to user equipment 114B-C to enable access to the new photo stored in a directory at memory 112. The enabled access to the new photo may be provided via an IP address, such as a mobile IPv6 home address provided by the home agent 180 configured as, for example, a dual-stack mobile IPv6.

In some exemplary embodiments, the content to be shared with the closed group, such as closed group 116, is stored in memory 112 within user equipment 114A. As such, the shared content does not leave user equipment 114A, so that the content is within the control of the user equipment 114A rather than another entity (e.g., a web-based photo service, a social networking web site, and the like). However, in some embodiments, the user equipment 114A may cache the shared content, such as a photo, a video, a music, a document, and the like, in a cache at home agent 180 or on a server on the path of the home agent 180. For example, when a new photo or content is created and the user equipment may experience multiple requests being received to view the content, the user equipment 114A may make the content available via a cache (e.g., content cache 295 at the home agent). This content may be made available for a time, such as for example a few minutes, hours, days, etc, to alleviate the bandwidth and capacity of the link over which the user equipment is connected.

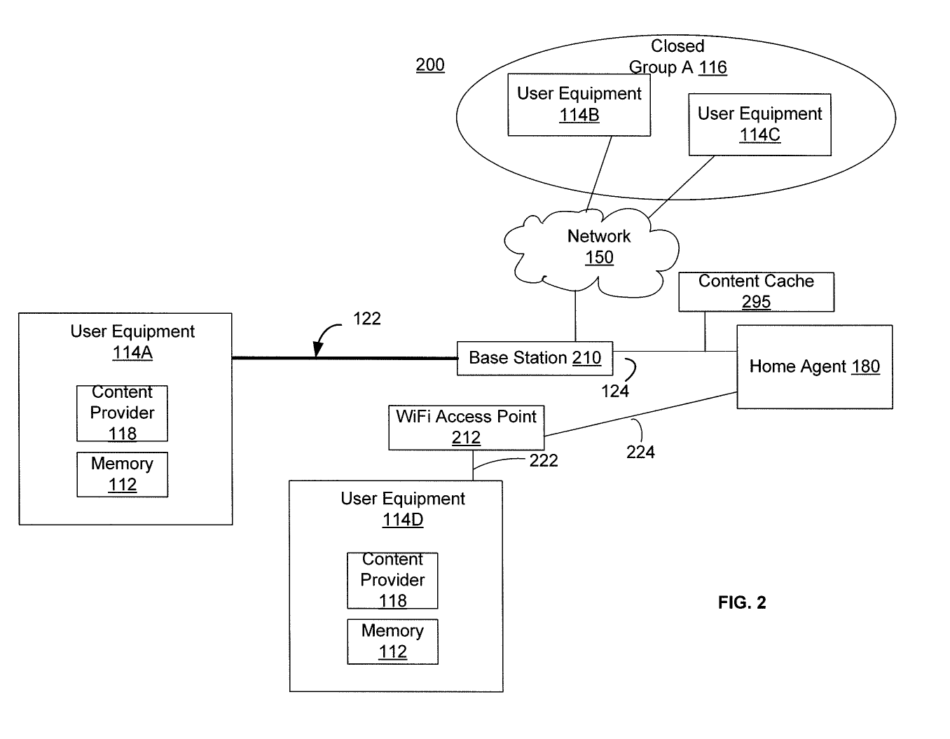

FIG. 2 depicts a system 200, which is similar to system 100 of FIG. 1 in some respects. However, system 200 includes user equipment 114A wirelessly coupling via link 122 to a base station 210, such as an evolved Node B base station, user equipment 114D wirelessly coupling via a link 222 to a WiFi access point 212, which is further coupled via link 224 to home agent 180. System 200 further includes content cache 295.

Although the following example refers to user equipment 114A, it is also applicable to other devices, such as user equipment 114D and the like. In the exemplary embodiment of FIG. 2, user equipment 114A may designate content for sharing with closed group 116 by storing, as noted above, the content in a specific directory in memory 112 and by storing the content for sharing in a specific location, such as a directory, in content cache 295. The shared content at content cache 295 may have an expiration time (e.g., a lifetime associated with the content stored in content cache 295), so that after the expiration the shared content will no longer be accessible (e.g., deletion upon expiration) from the content cache 295 but instead via content provider 118 and memory 112 at user equipment 114A. As such, user equipment controls access to the content at content cache 295 using the expiration time. Moreover, user equipment 114B-C designated within closed group 116 may access the content stored in content cache 295 (e.g., by accessing a uniform resource locator resolving to user equipment 114A which may redirect to the content at content cache 295), but once the access to the content expires, the user equipment 114B-C within closed group 116 may no longer access that content. Furthermore, when an expiration occurs, a notification message may be sent to user equipment 114A-C.

Moreover, when the content in the content cache 295 is deprecated as a result of the lifetime expiry, any requests for the content at the content cache 295 may be routed to the user equipment 114A, so that the content can still be made available from the user equipment 114A (not the content cache 295). In some implementations, the use of content cache 295 may optimize the sharing of content, such as a photo and the like, with a plurality of devices of a closed group which are allowed access to the shared content.

Caching content at content cache 295 may allow access to the shared content when user equipment 114A is inoperative, turned off, and the like. Furthermore, when a notification regarding shared content is sent to a relatively large number of user equipment, content cache 295 is accessed rather than memory 112 at user equipment 114A to mitigate the burden associated with repeated accesses to user equipment 114A, content provider 118, and memory 112. When data encryption is not used, content cache 295 may, in some exemplary embodiments, be implemented as, or placed adjacent to, a hyper text transfer protocol proxy to intercept hyper text transfer protocol requests destined for the user equipment 114A.

In some exemplary embodiments, content may be compressed before storing and sharing. For example, an eight megapixel photo may be automatically downscaled to a thumbnail sized image and/or a one megapixel photo. Compression may mitigate battery consumption and data volumes at user equipment 114A, although full size/uncompressed content may be shared as well.

In some exemplary embodiments, the content shared with closed group 116 may be visible only to the members of the closed group 116 and thus some form of security may be used to limit access to the shared content served by content provider 118 and stored at memory 112 (or content cache 295). The security mechanism may be a username and password mechanism. The security mechanism may also implement a so-called “cryptic” uniform resource locator (which points to user equipment 114A and/or content provider 118). For example, the cryptic uniform resource locator may be a very long string of numbers and letters to limit memorization or easy transcription. The security mechanism may also include other authentication mechanisms including certificate and key-based approaches. For example, the message notifying devices in closed group 116 of shared content may include a challenge, so that a device in the closed group is able to compute a response to that challenge (or sign a request message) to obtain access to the shared content at user equipment 114A.

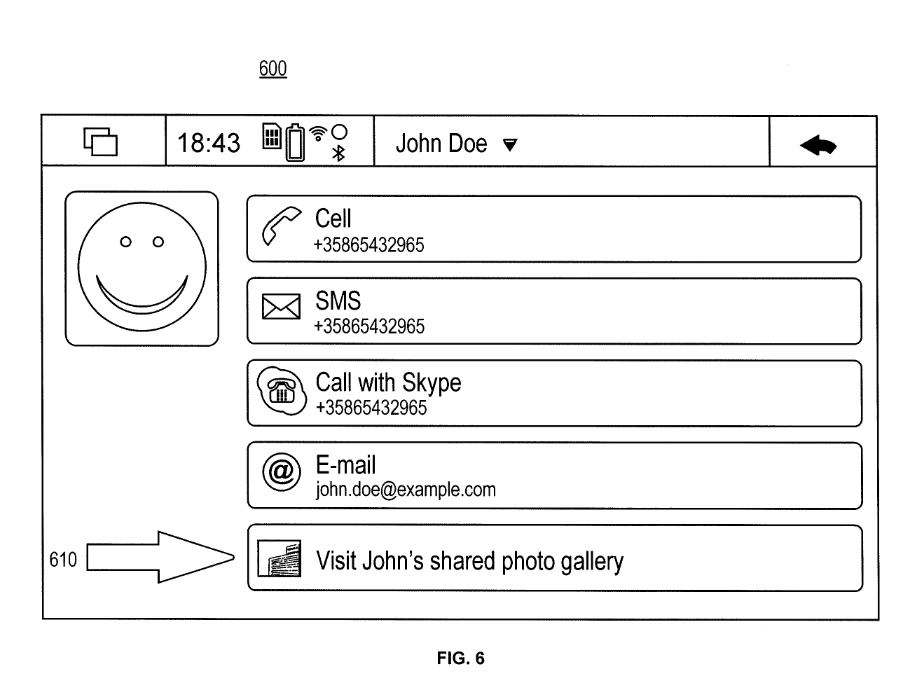

In some exemplary embodiments, when a device, such as user equipment 114B receives a first notification from user equipment 114A about being added to closed group 116, user equipment 114B-C may each store a corresponding bookmark for a uniform resource locator pointing to the shared content at user equipment 114A (e.g., pointing to the mobile home IP address assigned by the home agent 180). The user equipment 114B-C (which are the targets of the shared content) may also store a shared key, or secret, provided by the user equipment 114A to subsequently access content shared by the user equipment 114A. This bookmark may also include credentials for authenticating access to the shared content at user equipment 114A. Moreover, the bookmark, credential(s), and uniform resource locator may be stored in a phonebook application to indicate membership in closed group 116, as further described below with respect to FIG. 6.

In some exemplary embodiments, content may be automatically stored in content cache 295. For example, when a photo is taken by user equipment 114A and designated for sharing, the photo may be stored at content cache 295 for a period of time. In this example, when user equipment 114B starts to access the photo, the home agent 180 may determine that the photo is in content cache 295 (due to user equipment 114C's download) and provide the photo directly from content cache 295. In this example, if the photo had expired in content cache 295, the photo may be accessed directly from user equipment 114A. If the photo is not found in content cache 295, home agent 180 (and/or content cache 295) may direct the request for the photo to content provider 118. Moreover, the notification message may, in some exemplary embodiments, include the mobile IP home address of user equipment 114A, not the address of content cache 295 as content cache may detect any requests to the source of the content, such as the mobile IP home address of user equipment 114A, and then serve the content from content cache 295 when the content is available.

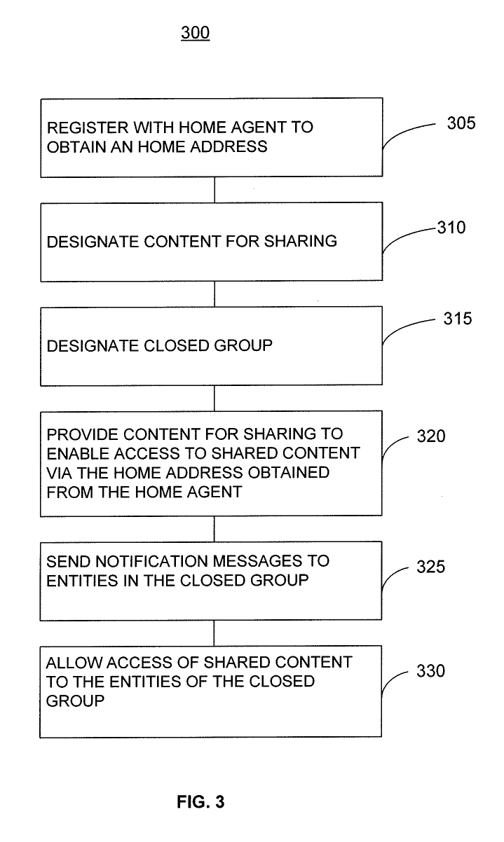

FIG. 3 depicts a process 300 for sharing content stored at a device, such as user equipment 114A consistent with some exemplary embodiments. The description of FIG. 3 also refers to FIGS. 1, 2, 4, and 5.

In some exemplary embodiments, a device may register, at 305, with a home agent to obtain a home address. For example, the user equipment 114A may register with the home agent 180 in order to obtain an IP address, such as a mobile IP home address. In some exemplary embodiments, home agent 180 may be configured with the dual-stack mobile IPv6 protocol in accordance with, for example, RFC-5555, Mobile IPv6 Support for Dual Stack Hosts and Routers, June 2009, and/or in accordance with transport layer security (TLS), such as for example draft-ietf-mext-mip6-tls (http://www.iet/org/id/draft-ietf-mext-mip6-tls-00.txt). As part of the registration, the user equipment 114A is assigned an IP address, such as a mobile IP home address, accessible to other devices in the network, such as the Internet. Although the device, such as user equipment 114A may obtain a stationary address, such as a mobile IP home address, from a registration with a home agent, the device may also obtain the stationary address by other mechanisms, such as over-the-air provisioning.

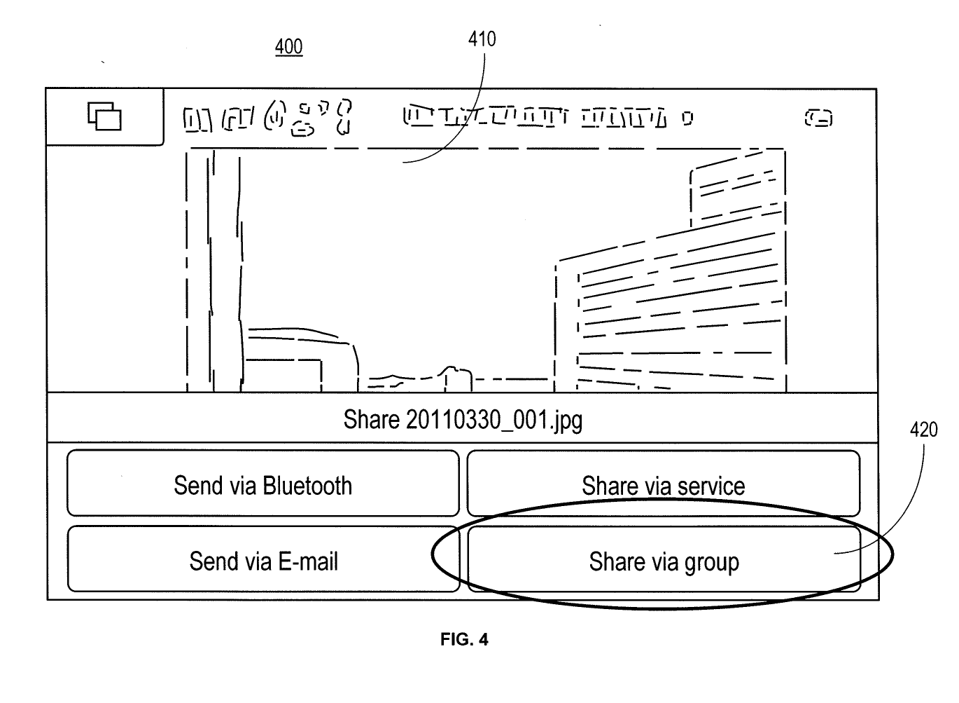

In some exemplary embodiments, content may be designated, at 310, for sharing. For example, user equipment 114A may designate content, such as a photo and the like for sharing. FIG. 4 depicts an example of designating content for sharing. Referring to FIG. 4, a page 400 generated for presentation at a user interface of user equipment 114A may be used to designate a photo 410 for sharing with one or more closed groups by selecting an icon, such as “Share via group” icon 420. The photo 410 may also be sent via Bluetooth, sent via email, and/or shared via a service. In the example of share via a service, the location of the shared content, such a uniform resource locator to the content at user equipment 114A, may be uploaded to a content sharing website, such as Facebook, so that the shared content is actually stored on user equipment 114A rather than the website.

In some exemplary embodiments, a group, such as a closed group, may be designated at 315. For example, user equipment 114A may designate devices (and/or corresponding users) to one or more closed groups. For example, user equipment 114A may be used to define one or more closed groups (which may also be private). Each closed group may include at least one device. In the example of FIG. 1, the user designates user equipment 11413-C to closed group “A” 116.

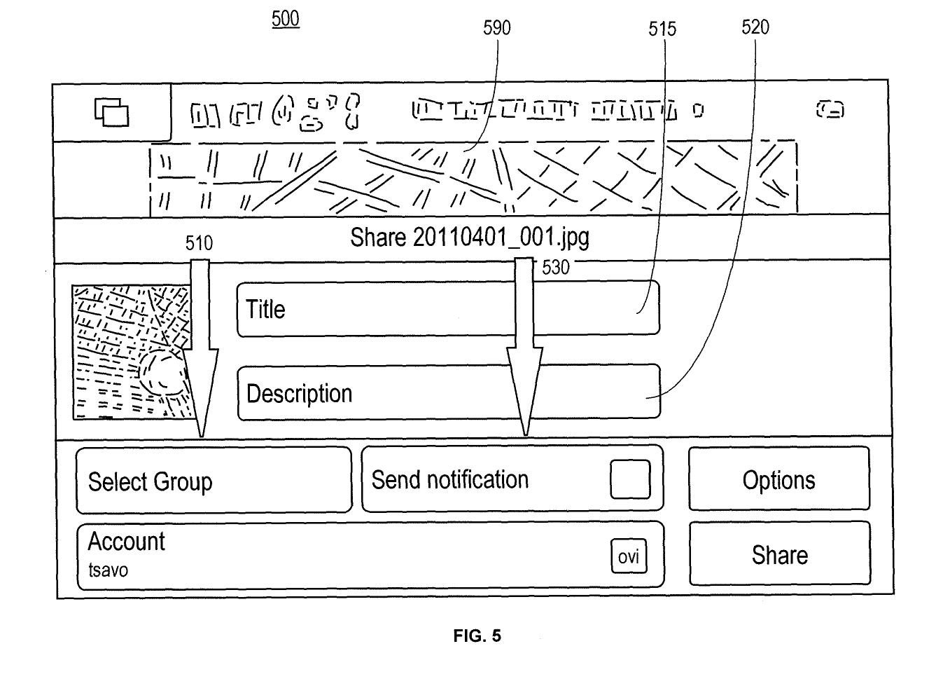

In some exemplary embodiments, content may be provided, at 320, for sharing to enable access to the shared content via the home address obtained from the home agent. For example, the shared content may be placed in a specific location, such as a directory in memory 112 and/or content cache 295, accessible to one or more designated groups. FIG. 5 depicts a page 500 generated for presentation at a user interface of user equipment 114A consistent with some exemplary embodiments. At page 500, the user equipment 114A designates content, such as photo 590, for sharing among a selected group via icon 510. When icon 510 is selected, one or more closed groups may be listed (e.g., as a so-called pick list) and then selected. When a group is selected, user equipment 114A may move content, such as photo 590, into a specific location accessible to the selected closed group.

In some exemplary embodiments, a notification message may be sent, at 325, to the devices in the group, such as the closed group. Referring again to FIG. 5, user equipment 114A may present page 500 including an icon 530, which initiates sending a notification message to the devices in the designated closed group. The page 500 may also include fields for metadata associated with the photo 590. For example, the photo 500 may be labeled with a title 515 and a brief description 520 of the photo 590. The title 515 and a brief description 520 may be included in the notification message sent to closed group 118. The notification message may include a locator, such as a uniform resource locator, to point to the location of the shared content (e.g., to a location associated with the mobile IP home address obtained from the home agent 180). The notification message may also include, as noted above, other information, such as a phonebook contact, credentials, and the like.

In some exemplary embodiments, access to the shared content may be allowed, at 330, to the devices in the closed group. Once notified, the devices in the closed group may be able to locate and thus access the content served by content provider 118 and stored in memory 112 (or cached at content cache 295). As noted above, a locator, such as a uniform resource locator, may direct a device in closed group 118 to the content served by content provider 118 and stored in memory 112 (or cached at content cache 295). For example, a uniform resource locator included in the notification message may link user equipment 114B to a mobile IP home address at home agent 180, which redirects user equipment 114B to user equipment 114A (which is registered at home agent 180). The user equipment 114B may then access content served by content provider 118 and stored in memory 112 (or cached at content cache 295), all the while, the user equipment 114A controls access to the content.

FIG. 6 depicts a page 600 generated for presentation at a user interface of user equipment 114A consistent with some exemplary embodiments. FIG. 6 depicts page 600 including contact information for “John Doe” including cell phone number, SMS contact, email, and the like. Page 600 also shows that the contact information for John Doe may include that person's shared content. For example, selecting icon 620 would provide information (e.g., the uniform resource locator, a bookmark, credentials, etc) for accessing the shared content served by content provider 118 and stored in memory 112 (or content cache 295). In this example, user equipment 114A may forward the phonebook contact information to devices in closed group 116, enabling the user equipment 114B-C to access John Doe's shared content at user equipment 114A.

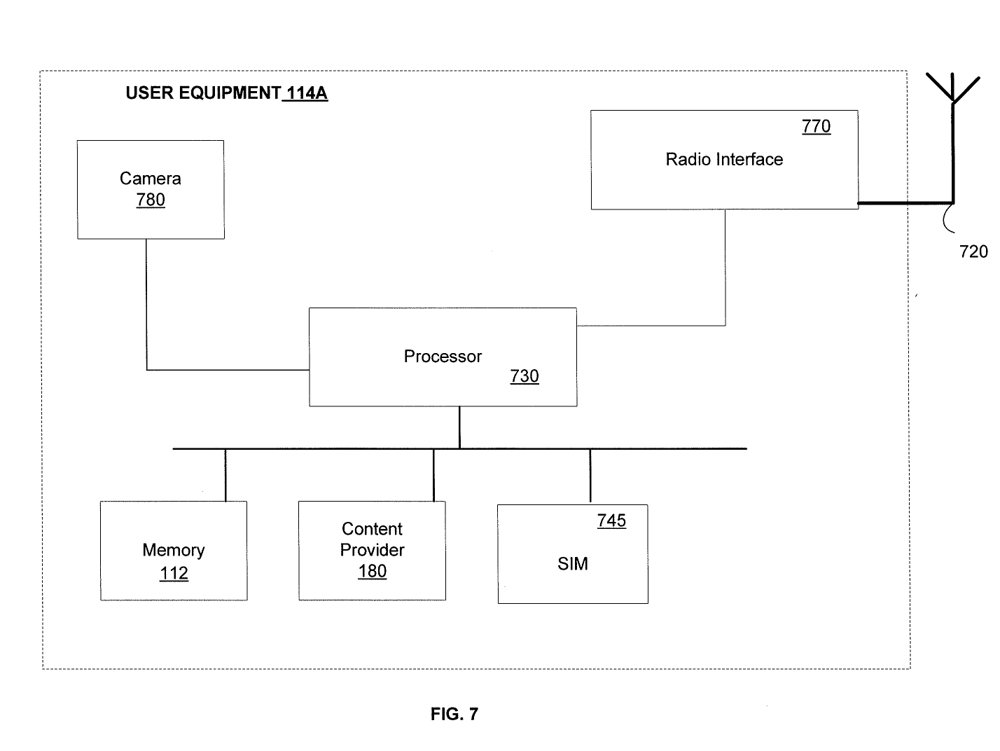

FIG. 7 depicts an example implementation of user equipment 114A consistent with some of the exemplary embodiments described herein. The user equipment 114A may include one or more of the following components: an antenna 720, a radio interface 770, a camera 780, a processor 730, a memory 112, a content provider 118, and a subscriber identity module 745 for authenticating the user equipment 114A, and the like.

In some exemplary embodiments, the antenna 720 may include one or more antennas. Moreover, the antenna 720 may couple signals to, and/or from, radio interface 770. The radio interface 770 may include one or more components, such as for example filters, converters (e.g., digital-to-analog converters and the like), processors, symbol demappers, an Inverse Fast Fourier Transform (IFFT) module, a Fast Fourier Transform module, a precoder, a demodulator, a modulator, and the like.

In some exemplary embodiments, the user equipment 114A may further include at least one processor 730 for controlling the user equipment 114A and for accessing and executing program code stored in at least one memory 112. In some exemplary embodiments, the processor 730 may include one or more of the following: one or more microprocessors; one or more processors with, or without, accompanying digital signal processor(s); one or more special-purpose computer chips; one or more field-programmable gate arrays (FPGAS); one or more controllers; one or more application-specific integrated circuits (ASICS), and/or one or more computers. In some implementations, the user equipment 114 may also be compatible with one or more of the following: HSPA, WiMAX, LTE, LTE-Advanced, and the like.

In some exemplary embodiments, the content provider 118 and memory 112 may be implemented as noted above.

In some exemplary embodiments, the subscriber identity module 745 may be used to authenticate user equipment 114 to a network, such as an operator of a public land mobile network (e.g., authenticating with an authentication server in the operator's network). For example, the subscriber identity module 745 may comprise a card, a module, and/or a circuit securely storing a secret key and the like to authenticate a user to the network.

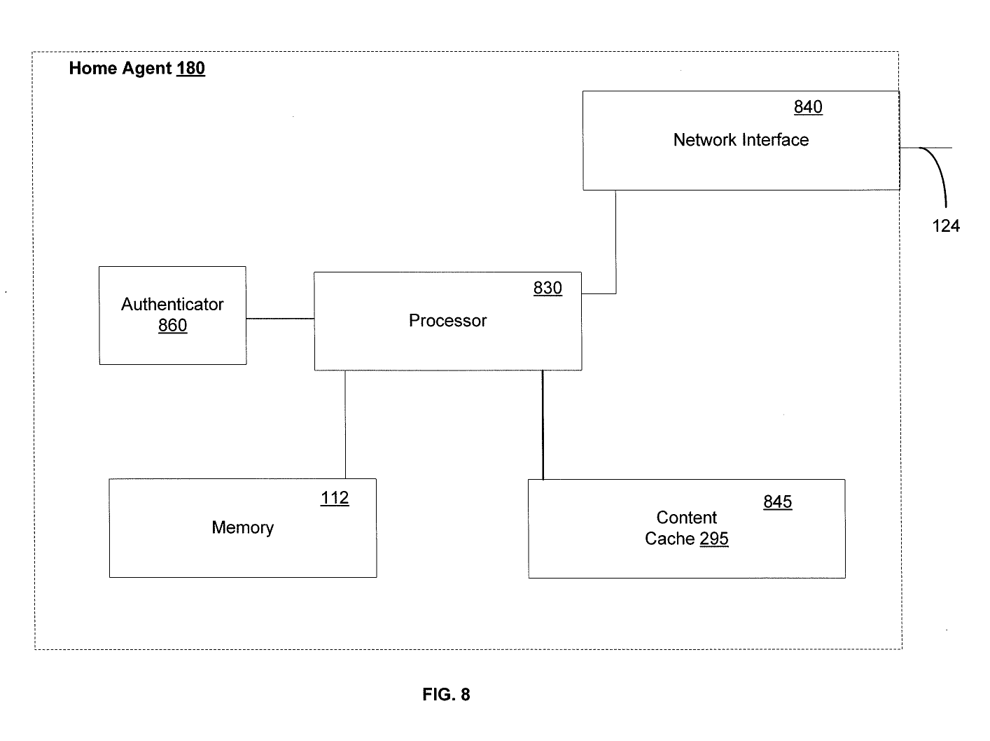

FIG. 8 depicts an example of a home agent 180 consistent with some exemplary embodiments. Home agent 180 may include a network interface 840 to provide wired and/or wireless access. The home agent 180 may also include an authenticator 860 which may use an authentication mechanism before granting an IP address, such as a mobile IPv6 home address, to a user equipment, such as user equipment 114A, registered at home agent 180. The authentication may be implemented as any form of authentication including a password, a subscriber identity module-based technique using keys (e.g., private keys), and the like. Content cache 295 may be implemented as described above at FIG. 2 but in the implementation of FIG. 8, content cache 295 is included within home agent 180.

In some exemplary embodiments, the processor 830 may include one or more of the following: one or more microprocessors; one or more processors with, or without, accompanying digital signal processor(s); one or more special-purpose computer chips; one or more field-programmable gate arrays (FPGAS); one or more controllers; one or more application-specific integrated circuits (ASICS), and/or one or more computers.

The memory 835 may, in some exemplary embodiments, include one or more of the following: read-only memory, random access memory, FLASH memory, and any other mechanism configured to store and/or retain information. For example, the memory 835 may be used to store content to be shared with a closed group. The memory 835 may also store other information, such as for example code/instructions to provide the operations disclosed herein.

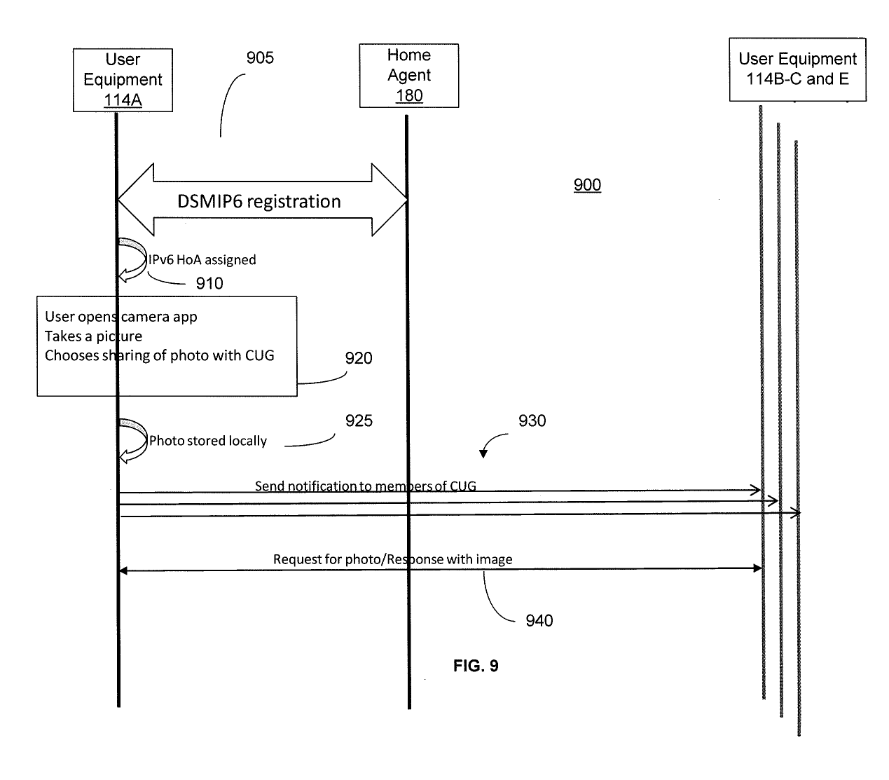

FIG. 9 depicts a sequence diagram 900 consistent with some exemplary embodiments. The sequence diagram includes user equipment 114A, home agent 180, and devices such as user equipment 114B-C and a user equipment 114E.

In some exemplary embodiments, user equipment 114A may register at 905 with the home agent 180. The registration 905 may, in some implementations, be in accordance with a dual-stack mobile internet protocol. The registration may provide a mobile IP home address at 910. When a user generates content, such as taking a picture with a camera at user equipment 114A, the user equipment 114A may designate, at 920, the content for sharing within closed group 116 (also referred to as closed user group (CUG)). Moreover, the content may be stored, at 925, locally in, for example, memory 112 (or content cache). The user equipment 114A may also send, at 930, notification messages to devices in the closed group 116 notifying the devices that the content is available for access at user equipment 114A. At 940, one or more of user equipment 114B-C may request access to the content stored, for example, in memory 112 by accessing a locator, such as a uniform resource locator linking via the mobile IP home address (and a corresponding care-of address) to user equipment 114A and/or content provider 118.

The features, structures, or characteristics described throughout this specification may be combined in any suitable manner in one or more embodiments. For example, the usage of the phrases “exemplary embodiments,” “example embodiments,” “some embodiments,” or other similar language, throughout this specification refers to the fact that a particular feature, structure, or characteristic described in connection with an embodiment may be included in at least one embodiment described herein. Thus, appearances of the phrases “exemplary embodiments,” “example embodiments,” “in some embodiments,” “in other embodiments,” or other similar language, throughout this specification do not necessarily all refer to the same group of embodiments, and the described features, structures, or characteristics can be combined in any suitable manner in one or more embodiments.

As discussed above, various embodiments of the invention may be configured in numerous physical elements, or can be configured at a single network element, or configured in a number of elements having various disclosed functions distributed throughout. Moreover, the examples above describing specific types of content are merely illustrative as any type of content may be shared.

The subject matter described herein may be embodied in systems, apparatus, methods, and/or articles depending on the desired configuration. For example, the user equipment, base station, and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Moreover, the term “exemplary” as used herein refers to an “example.” Furthermore, the term “group” may include one or more entities. Other embodiments may be within the scope of the following claims.

22-30. (canceled)

1. A method comprising:
serving, by a mobile device, as a content provider;
storing, in the mobile device, content in a secured location represented by an identifier reachable by another device, wherein the secured location is under the control of the mobile device; and
sharing with the other device stored content by enabling access to the stored content in the secured location represented by the identifier and located in the mobile device.

2. The method of claim 1, wherein the identifier further comprises at least one of an internet protocol address and an associated uniform resource locator resolvable by the other device, wherein the identifier is received after authentication by the mobile device using a private key.

3. The method of claim 1 further comprising:
controlling access to the content stored in the secured location by enabling access to the content based on a designation, by the mobile device, of a group, wherein the other device is part of a group comprising at least one of a plurality of devices.

4. The of claim 3 further comprising:
designating, at the mobile device, the group by receiving a selection of the at least one of the plurality of devices.

5. The method of claim 3 further comprising:
designating, at the mobile device, the content for sharing among the group, wherein the designated content is stored in the location under the control of the mobile device.

6. The method of claim 3 further comprising:
sending a notification message including the identifier to the group to notify the at least one of the plurality of devices of the stored content available in the secured location under the control of the mobile device.

7. The method of claim 2, wherein the internet protocol address is a home address assigned by a home agent:
accessing, by the group comprising the at least one of a plurality of entities, the stored content in the location comprising a directory.

8. The method of claim 7, wherein the home address is based at least on a dual-stack mobile internet protocol address.

9. The method of claim 1, wherein the content for sharing includes an expiry time defined by the mobile device to control access to the content.

10. The method of claim 3, wherein the group comprises a closed group.

11. An apparatus comprising
at least one processor; and
at least one memory including computer program code, the at least one memory and the computer program code configured to, with the at least one processor, cause the apparatus to at least:
serve, by the apparatus, as a content provider, wherein the apparatus comprises a mobile device;
store mobile device, content in a secured location represented by an identifier reachable by another device, wherein the secured location is under the control of the mobile device; and
share with the other device the stored content by enabling access to the stored content in the secured location represented by the identifier and located in the mobile device.

12. The apparatus of claim 11, wherein the identifier further comprises at least one of an internet protocol home address and an associated uniform resource locator resolvable by the other device, wherein the identifier is received after authentication by the mobile device using a private key.

13. The apparatus of claim 11, wherein the apparatus is further configured to at least control
access to the content stored in the secured location by enabling access to the content based on a designation, by the mobile device, of a group, wherein the other device is part of a group comprising at least one of a plurality of devices.

14. The apparatus of claim 13 wherein the apparatus is further configured to at least designate,
at the mobile device, the group by receiving a selection of the at least one of the plurality of devices.

15. The apparatus of claim 13 wherein the apparatus is further configured to at least designate,
at the mobile device, the content for sharing among the group, wherein the designated content is stored in the location under the control of the mobile device.

16. The apparatus of claim 13 wherein the apparatus is further configured to at least send
a notification message including the identifier to the group to notify the at least one of the plurality of devices of the stored content available in the secured location under the control of the mobile device.

17. The apparatus of claim 12 wherein the internet protocol address is a home address assigned by a home agent
accessing, by the group comprising the at least one of a plurality of entities, the stored content in the location comprising a directory.

18. The apparatus of claim 17, wherein the home address is based at least on a dual-stack mobile internet protocol address.

19. The apparatus of claim 11, wherein the content for sharing includes an expiry time defined by the mobile device to control access to the content.

20. The apparatus of claim 13, wherein the group comprises a closed group.

21. A non-transitory computer program product comprising machine-readable medium storing instructions that, when executed by at least one processor, cause the at least one processor to perform operations comprising:
serving, by a mobile device, as a content provider;
storing, in the mobile device, content in a secured location represented by an identifier reachable by another device, wherein the secured location is under the control of the mobile device; and
sharing with the other device stored content by enabling access to the stored content in the secured location represented by the identifier and located in the mobile device.
